(19) United States
(12) Patent Application Publication
(10) Pub. No.: US 2008/0100055 A1
(43) Pub. Date: May 1, 2008

(54) IDENTIFICATION TAG

(75) Inventor: Gary Loomis, Woodland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: TARGUS FLY FEATHERS INDUSTRIES, Mesa, AZ (US)

(21) Appl. No.: 11/834,543

(22) Filed: Aug. 6, 2007

Related U.S. Application Data
(60) Provisional application No. 60/835,809, filed on Aug. 4, 2006.

(51) Int. Cl. B42D 15/00

(52) U.S. Cl. 283/74

(57) ABSTRACT

An identification device attachable to a product is provided. The identification device includes a tag having at least one face for bearing identification information, and a tail having first and second ends. The tail is couplable to the tag at its first end such that it extends outwardly therefrom. The second end of the tail is adapted to pass through a portion of the product and thereafter be enlarged.

### CROSS-REFERENCE TO RELATED APPLICATION

This application claims the benefit of U.S. Provisional Application No. 60/835,809, filed Aug. 4, 2006, the disclosure of which is hereby expressly incorporated by reference, and priority from the filing date of which is hereby claimed under 35 U.S.C. §119(e).

### BACKGROUND

Products for sale are often labeled with a Universal Product Code (UPC), which provides information relating to that particular product. Selling a product or tracking a product without a UPC often leads to errors in inventory control, pricing, and tracking of the products. Thus, use of a UPC is practically essential for the modem business world.

Many smaller products do not lend themselves to application of a label carrying a UPC. These products often come in bulk and are not individually packaged, so the UPC label cannot be applied externally to a bag, box, or other type of packaging. For instance, bulk items commonly found at sporting goods stores, such as fishing flies, fishing sinkers, etc., would have a significant price increase if they needed to be individually packaged to carry a UPC. A label or other type of packaging also leaves room for the application of other product information, such as the brand name, the product name, etc. This is important so that consumers may distinguish between products when making a selection.

A known form of identification devices includes a tag having a tail with a T-bar end portion, wherein the T-bar portion is inserted into a product by deforming the T-bar portion and aligning it with the tail and thereafter allowing the T-bar portion to return to a 90° orientation relative to the tail. This arrangement is not feasible with a small product, such as a fish hook, which has a very small insertion portion, such as an eye. Thus, it is desired to have an identification device that is attachable to small products.

### SUMMARY

An identification device attachable to a product is provided. The identification device includes a tag having at least one face for bearing identification information, and a tail having first and second ends. The tail is couplable to the tag at its first end such that it extends outwardly therefrom. The second end of the tail is adapted to pass through a portion of the product and thereafter be enlarged.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a front plan view of a first embodiment of an identification device coupled to a fishing fly, wherein the identification device includes a tag and a tail extending therefrom;

FIG. 2 is a front plan view of a second embodiment of an identification device coupled to a fishing fly, wherein the identification device includes a tag and a tail extending therefrom;

FIG. 3 is a front plan view of a third embodiment of an identification device coupled to a fishing fly, wherein the identification device includes a tag and a tail extending therefrom;

FIG. 4 is a front plan view of a fourth embodiment of an identification device coupled to a fishing fly, wherein the identification device includes a tag and a tail passing therethrough;

FIG. 5 is a side plan view of a fifth embodiment of an identification device coupled to a fishing fly, wherein the identification device includes a tag and a tail passing therethrough;

FIG. 6 is a side plan view of a sixth embodiment of an identification device coupled to a fishing fly, wherein the identification device includes a tag and a tail passing therethrough;

FIG. 7 is a side plan view of a seventh embodiment of an identification device coupled to a fishing fly, wherein the identification device includes a tag and a tail passing therethrough;

FIG. 8 is a side plan view of a eighth embodiment of an identification device coupled to a fishing fly, wherein the identification device includes a tag and a tail passing therethrough;

FIG. 9 is a front plan view of a ninth embodiment of an identification device coupled to a fishing fly, wherein the identification device includes a tag and a tail coupled thereto;

FIG. 10A is a front plan view of a tenth embodiment of an identification device coupled to a fishing fly, wherein the identification device includes a tag and a loop coupled thereto;

FIG. 10B is a side plan view of the identification device of FIG. 10A, wherein the loop is passing through an opening in the tag;

FIG. 11A is a front plan view of a twelfth embodiment of an identification device coupled to a fishing fly, wherein the identification device includes a tag and a clip coupled thereto;

FIG. 11B is a front plan view of the identification device of FIG. 11A, wherein the clip is passing through an opening in the tag;

FIG. 12 is a front plan view of a twelfth embodiment of an identification device coupled to a fishing fly, wherein the identification device includes a tag and a wire form coupled thereto; and

FIG. 13A is a front plan view of a thirteenth embodiment of an identification device coupled to a fishing fly, wherein the identification device includes a tag and a loop member coupled thereto; and

FIG. 13B is a front plan view of the identification device of FIG. 13A, wherein the fishing fly is coupled to the tag.

### DETAILED DESCRIPTION

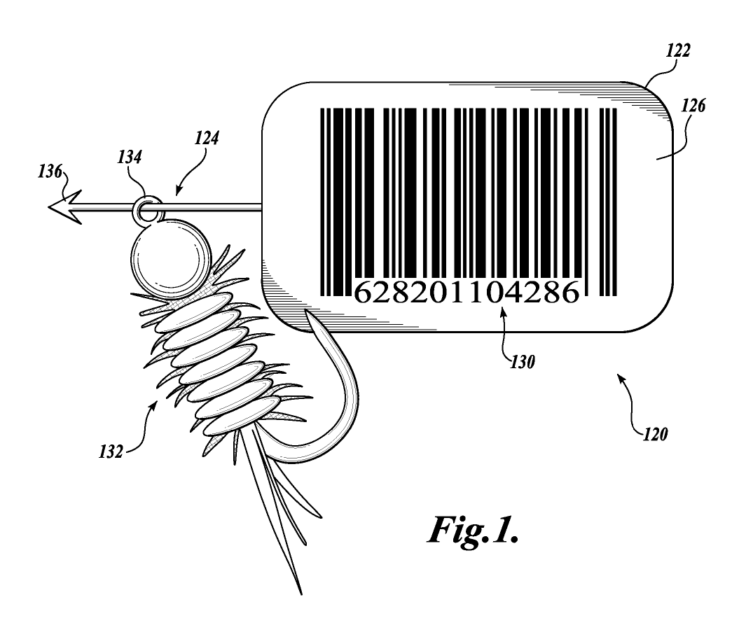

A first embodiment of an identification device 120 suitable for use with a variety of products may be best understood by referring to FIG. 1. The identification device 120 is suited for providing identification information for a product 132. Although the identification device 120 is shown with a fishing fly 134, it should be apparent that the scope of the present disclosure is not intended to be so limiting and the identification device 120 may instead be used with any suitable product.

Referring to FIG. 1, a first embodiment of an identification device 120 includes a label-bearing tag 122 having a first side 126 and a second side (not shown). The tag 122 includes product-identifying information or other suitable information or markings on the first side 126 and/or the second side of the tag 122. The tag 122 is shown having a UPC 130 printed on the first side 126. However, it should be appreciated that other types of product information, such as the price, name, trademark, etc., may be included on the tag 122. Moreover, the product information may either be printed on the tag 122 or printed on a separate label and thereafter mounted to the tag.

The tag 122 is sufficiently shaped and sized to contain the desired information that identifies the product 134. Although the tag 122 may be any shape and size, the tag 122 is preferably rectangular and flat and is approximately 0.7 inches long, 0.4 inches high, and has a nominal thickness of 0.02 inches. The tag 122 is made from any suitable material that is adapted to accept either printed information or the adhesive of a printed label. Preferably, the tag 122 consists of a polymer material, such as nylon, and it may be clear, translucent, or opaque.

The identification device 120 further includes a tail 24 that extends laterally of or from a side of the tag 122 and is substantially co-planar therewith. Preferably, the tail 124 is made from the same material as the tag 122 or another semi-deformable material. The tail 124 has a nominal diameter of approximately 0.02 inches. The tail 124 may be of uniform thickness along the length of the tail 124, or it may instead decrease in thickness near the distal portion of the tail to a diameter of about 0.01 inches. The tail 124 also has a nominal length of approximately 1.125 inches, and if the tail 124 varies in thickness along the length of the tail 124, the proximal portion is about one inch, and the distal portion is about 0.125 inches. It should be appreciated that the above-provided dimensions are for descriptive purposes only, and the tail 124 may instead be any suitable size that is receivable within a portion of the product 132.

The end of the tail 124 opposite the tag 122 includes a self-expanding, deformable end tip portion 136, such as a deformable arrow tip, that may be passed through a portion of the product 132. The self-expanding end portion 136 is sized to deformably pass through the eye 134 and thereafter expand or return to its non-deformed, original shape. With the end of the tail 124 “expanded” as such, the tail 124 cannot be readily pulled through the eye 134 in the reverse direction, and the tag 122 is secured to the product 132.

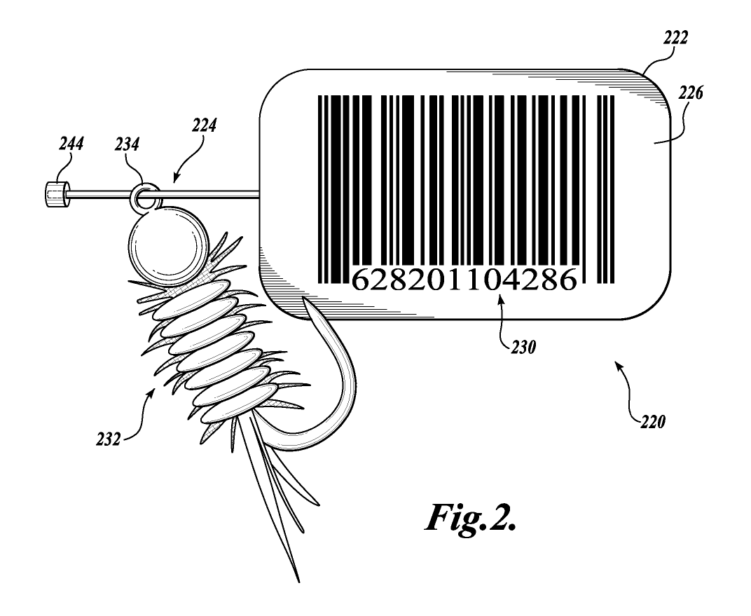

Referring to FIG. 2, a second embodiment of the identification device 220 includes a tag 222 having a tail 224 substantially identical to the tail 124 of the first embodiment, except that the end of the tail 224 is adapted to receive an end cap 244 or similar element. The tail 224 is passed through the eye 234 of the product 232 and thereafter receives the end cap 244. In this manner, the tail 224 is enlarged and cannot thereafter be pulled through the eye 234 in the reverse direction.

The end cap 244 may be any suitable plastic component that is securable to the end of the tail 224. For instance, a plurality of annular striations or grooves may be formed on the end of the tail 224 transverse to the longitudinal axis of the tail 224. In this configuration, the end cap 244 includes a suitable opening for receiving the end of the tail 224, and within the opening are annular protrusions (not shown) that substantially conform to the shape and size of the annular grooves formed on the tail 224. When the end of the tail 224 is inserted into the end cap 244, the annular protrusions within the end cap 244 are received within the annular grooves of the tail 224. In this manner, the end cap 244 may be “snap fit” onto the end of the tail 224.

In an alternative configuration, the end cap 244 may instead be a piece of thermoplastic material that, when positioned near the end of the tail 224, is heated to adhere to the end of the tail 224 to define an enlarged, expanded end. It should be appreciated that the end cap 244 may be formed in any suitable manner, and it may likewise be secured to the end of the tail 224 in any way sufficient to define an expanded end for preventing the tail 224 from being pulled through the eye 234 after it is passed therethrough.

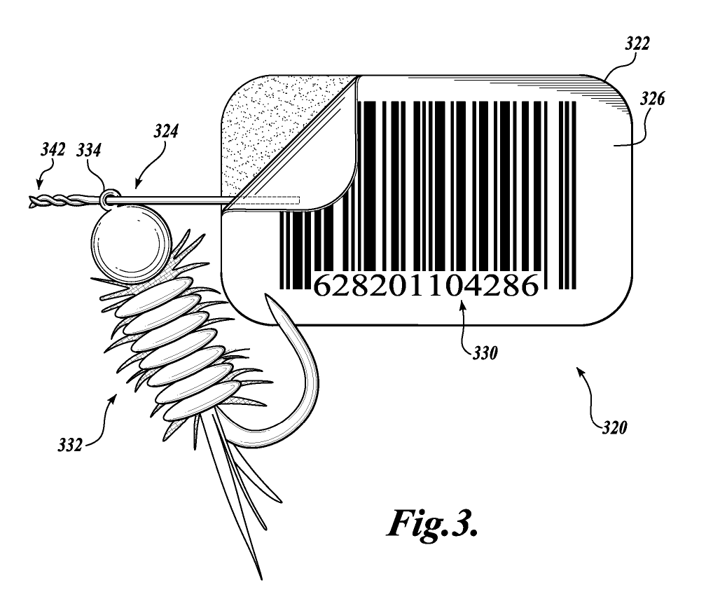

Referring to FIG. 3, a third embodiment of the identification device 320 includes a tag 322 having a tail 324 substantially identical to the tail 124 of the first embodiment, except that at least the end portion of the tail 324 is made of a bendable, shapeable material, such as wire. The tail 324 is passed through the eye 334 of the product 332, and the end of the tail 324 is thereafter deformed by bending, twisting, etc., such that the end of the tail 324 is enlarged. In this manner, the tail 324 cannot thereafter be pulled through the eye 334 in the reverse direction. It should be appreciated that the entire tail 324 may instead be formed of a bendable, shapeable material. With the tail 324 formed with a different material, it is likely formed separately from the tag 322 and thereafter coupled to the tag 322 in any suitable manner. For instance, the tag 322 may instead be formed from two labels secured back to back to each other, and a portion of the tail 324 may be disposed between the two labels forming the tag 322 such that the tail 324 is secured to the tag 322.

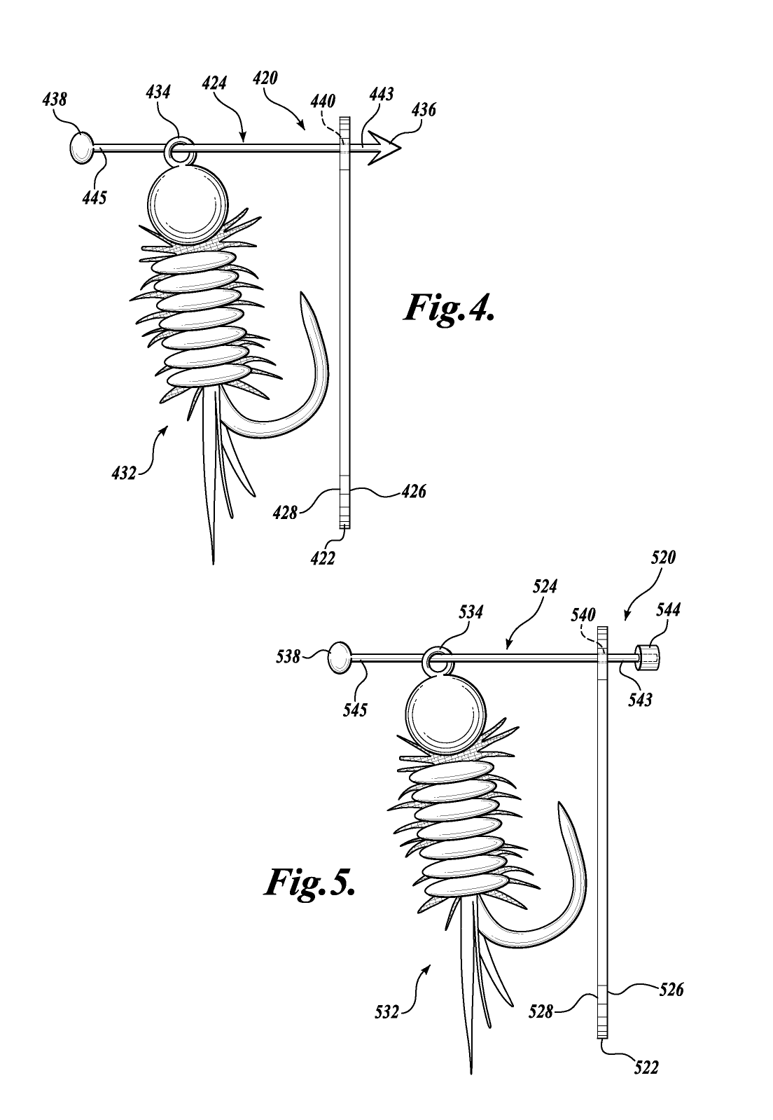

Referring to FIG. 4, a fourth embodiment of the identification device 420 includes a tag 422 substantially identical to tag 122 of the first embodiment, except that a tag through hole 440 is formed transversely in the tag 422 near one end of the tag 422. The identification device 420 includes a tail 424 that is formed separately from the tag 422. The tail 424 may be formed from a substantially similar material as the tag 422; however, any suitable material may be used.

The first end 443 of the tail 424 may be formed with a self-expanding end portion 436, such as a deformable arrow tip 436 like that described above with respect to the first embodiment of the identification device 120. The second end of the tail 445 includes an expanded portion which is formed by heating the end of the tail 424 such that the polymer of the tail 424 expands. Expansion may be accomplished by any number of techniques, including heating, crimping, flaring, spreading, etc.

To couple the product 432 to the tag 422, the self-expanding end portion 436 is first passed through the eye 434 of the product 432 and is thereafter passed through the tag through hole 440. After passing through both the eye 434 and the through hole 440, the self-expanding end portion 436 returns to its original shape such that the tail 424 cannot be pulled through the tag 422 or the eye 434 in the reverse direction, and the tag 422 is secured to the product 432. Moreover, the expanded end 438 retains the product 432 on the tail 424. It should be appreciated that the second end 445 of the tail 424 may instead be passed through the eye 434 and the tag through hole 440 and thereafter expanded by heating, crimping, flaring, etc. to form the expanded end 438 and retain the product 432 on the tail 424.

Referring to FIG. 5, a fifth embodiment of the identification device 520 is substantially identical to the fourth embodiment of the identification device 420 except that the first end 543 of the tail 524 is adapted to receive an end cap 544 that is substantially similar to the end cap 244 described above. The first end 543 of the tail 524 is passed through both the eye 534 and the through hole 540 and thereafter receives the end cap 544 to secure the product 532 onto the tail 524. The second end 545 of the tail 524 is expanded in a similar fashion as described above by heating, crimping, flaring, spreading, etc., either before or after the tail 524 is passed through the eye 534 and the tag 522.

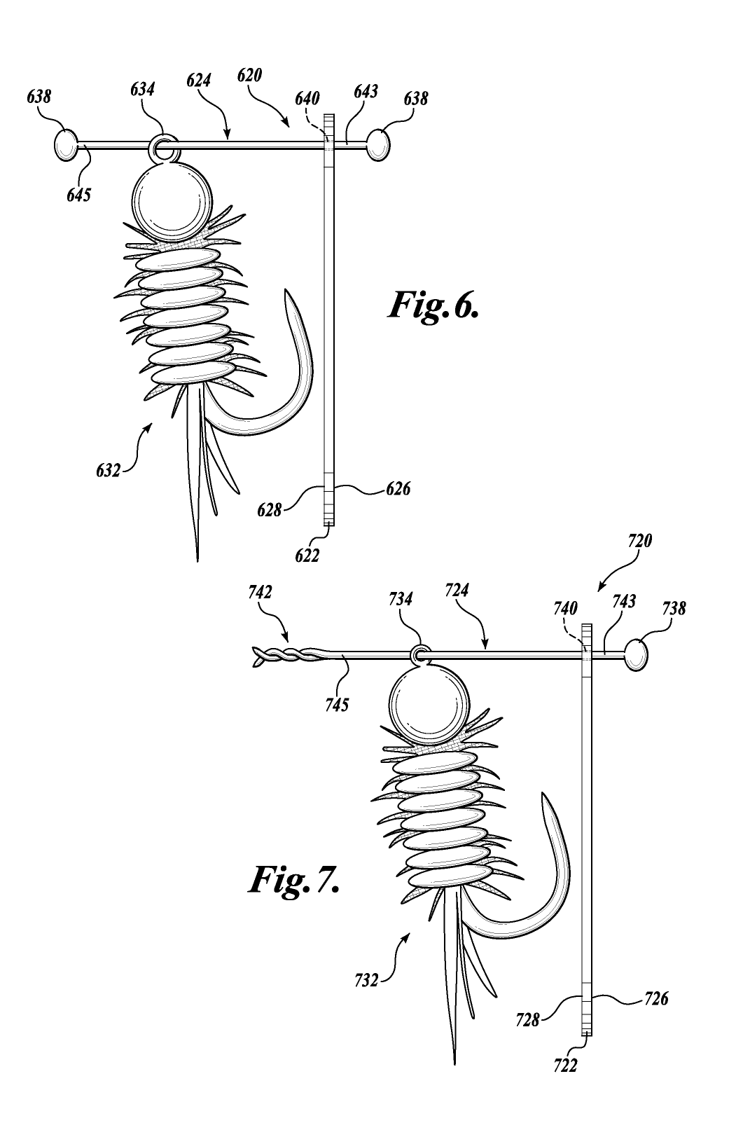

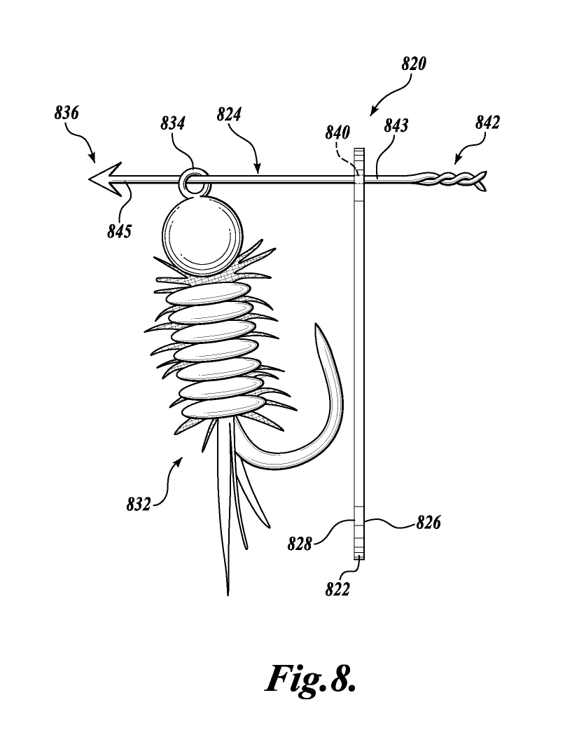

FIGS. 6-8 depict sixth, seventh, and eighth embodiments of identification devices 620, 720, and 820, respectively. The identification devices 620, 720, and 820 are substantially identical to the identification devices 420 and 520. Identification device 620, however, includes expanded ends 638 at both the first and second ends 643 and 645 of the tail 624. The identification device 720 includes an expanded end 738 at the first end 743 of the tail 724, and it includes a twisted or deformed end 742 at the second end 745 of the tail 724. The identification device 820 includes a twisted or deformed end 842 at the first end 843 of the tail 824, and it includes a self-expanding end portion 836 at the second end 845 of the tail 824. It should be appreciated that the first and second ends of the tail may be expanded or enlarged in any other suitable manner, and any other combination of enlarged or expanded ends may be used.

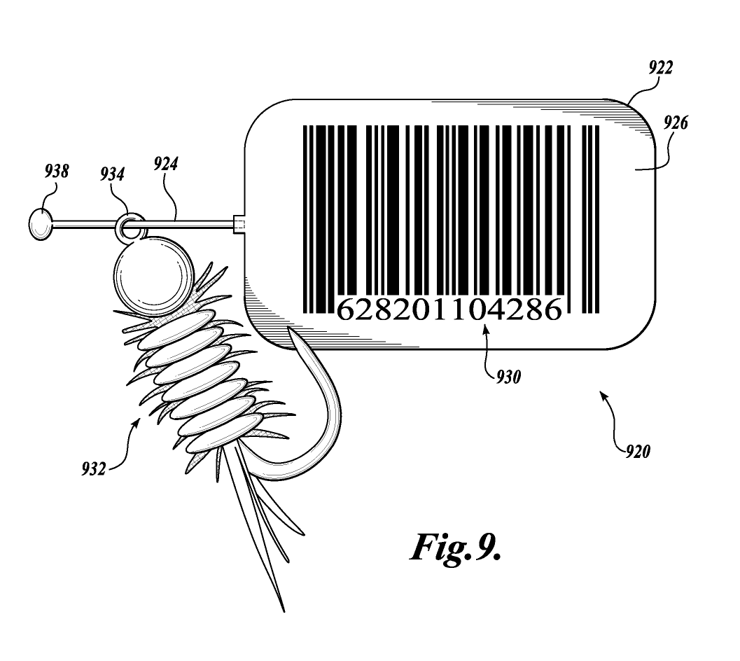

Referring to FIG. 9, a ninth embodiment of the identification device 920 is similar to the embodiments shown in FIGS. 5-8, except the tail 924 is instead coupled to the tag 922 while remaining co-planar therewith. The tail 924 may be coupled to the tag 922 at one end in any suitable manner; however, it is preferred that the end of the tail is disposed between first and second labels adhered back to back, wherein the labels define the tag 922. The other end of the tail 924 is shown having an enlarged end 938; however, the end may instead be enlarged by using an end cap, using a self-expanding end portion, or twisting or deforming the end. The tail 924 is passed through the eye 934 of the product 932, and the end of the tail 924 is enlarged by one of the above-described methods to retain the product 932 on the tail 924.

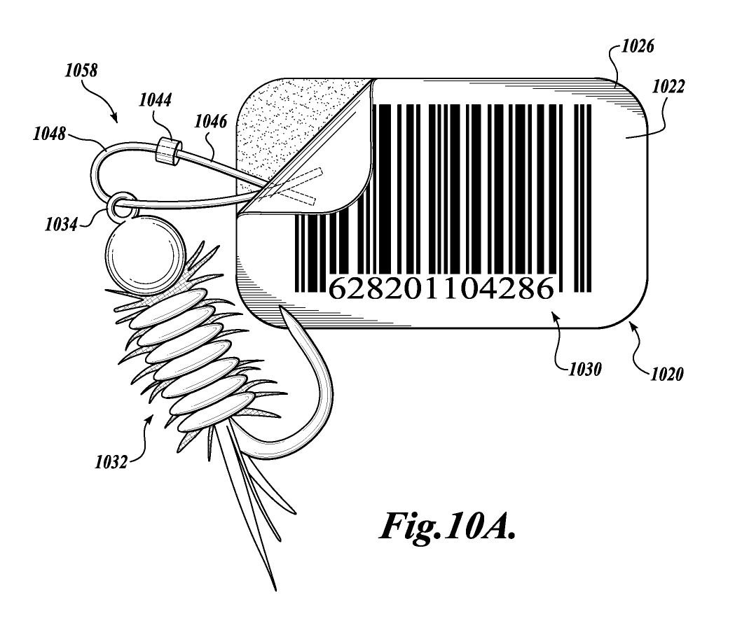

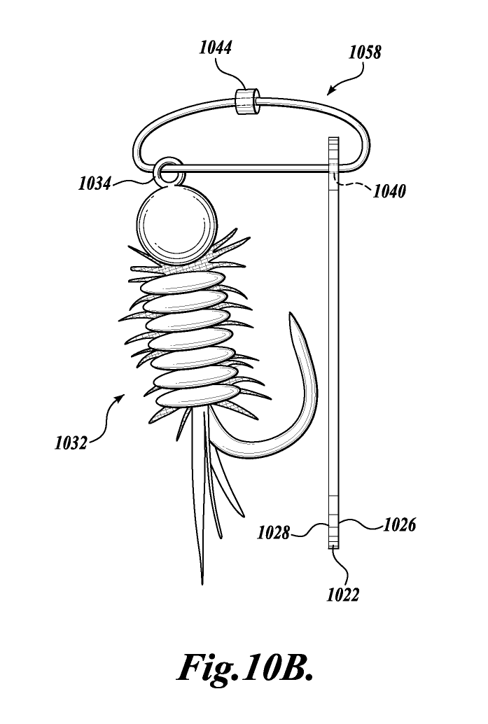

Referring to FIGS. 10A and 10B, a tenth embodiment of the identification device 1020 includes a tag 1022 substantially identical to tag 122 of the first embodiment. A flexible element, or loop 1058 extends from the tag 1022. Referring to FIG. 10A, the loop 1058 extends from the side of the tag 1022 and is substantially co-planar therewith. The end of the loop 1058 is coupled to the tag 1022 at one end in any suitable manner; however, it is preferred that the end of the loop 1058 is disposed between first and second labels adhered back to back, wherein the labels define the tag 1022. In the alternative, the loop 1058 may instead pass through a tag through hole 1040, as shown in FIG. 10B.

The loop 1058 is separable into a first loop portion 1046 and a second loop portion 1048. The first and second loop portions 1046 and 1048 extend from the side of the tag 1022 and are coupled at their ends in any suitable manner. In one non-limiting example, the ends of the first and second loop portions 1046 and 1048 are received within an end cap 1044 in a manner similar to that described above with respect to the second embodiment of the identification device 220. Instead, the first or second loop portion 1046 or 1048 may be formed with an end cap thereon such that the other of the first or second loop portion 1046 or 1048 may be received within the end cap 1044.

As another non-limiting example, the ends of the first and second loop portions 1046 and 1048 may be secured together by heating each end to melt the ends together. As yet another non-limiting example, the first and second loop portions 1046 and 1048 may be formed with a bendable, shapeable material, such as wire, such that the ends of the first and second loop portions 1046 and 1048 may be twisted together. It should be appreciated that the ends of the first and second loop portions 1046 and 1048 may instead be coupled together in any other suitable manner.

Before the first and second loop portions 1046 and 1048 are coupled together, the first or second loop portion 1046 or 1048 is passed through the eye 1034 of the product 1032. In this manner, the tag 1022 is coupled to the product 1032 through the loop 1058.

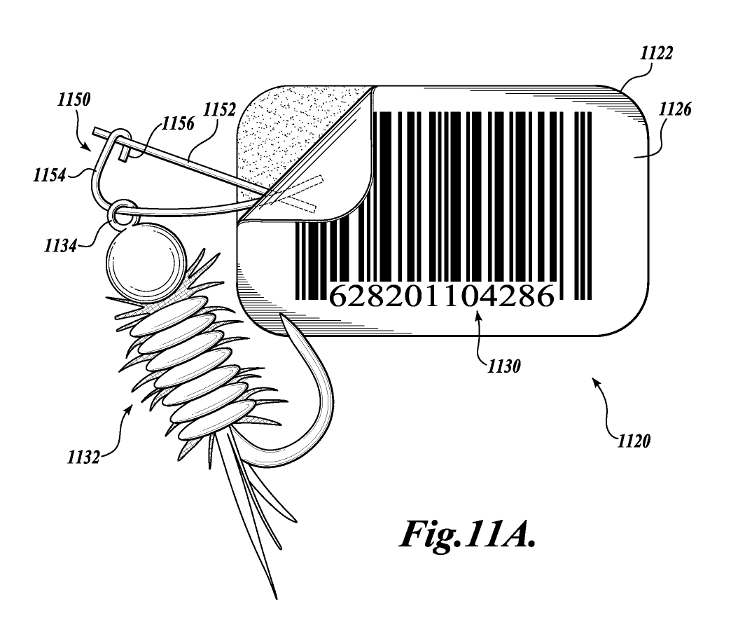

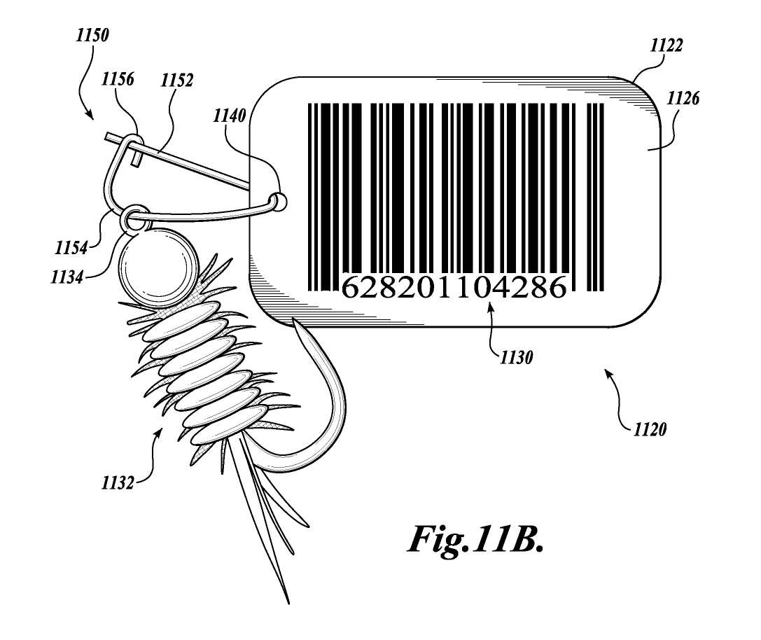

Referring to FIGS. 11A and 11B, an eleventh embodiment of the identification device 1120 includes a tag 1122 substantially identical to the tag 122 of the first embodiment. Referring to FIG. 11A, the identification device 1120 includes a flexible element, or a clip 1150 extending from the side of the tag 1122 and substantially co-planar therewith. The clip 1150 is formed from a bendable, shapeable material, such as wire. It is secured to the tag 1122 in any suitable manner, such as by disposing a portion of the clip 1150 between first and second labels adhered back to back that form the tag 1122. In the alternative, the clip 1150 may be secured to the tag 1122 by passing a portion of the clip 1150 through an tag through hole 1140 in the tag 1122, as shown in FIG. 11B.

The clip 1150 includes a clip straight portion 1152 and a clip curved portion 1154, with both portions extending from the tag 1122. The clip curved portion 1154 is shaped so as to extend away from the tag 1122 and thereafter bend towards the clip straight portion 1152. The end of the clip curved portion 1154 is bent back towards the curved portion 1154 to define a hook 1156. To couple the clip 1150 to the product 1132, the clip straight portion 1152 is passed through the eye 1134 of the product 1132 and is thereafter bent towards the clip curved portion 1154 until is passes over the hook 1156 and it received within the hook 1156, thereby “closing” the clip 1150. When the clip 1150 is closed, the product 1132 is secured to the tag 1122.

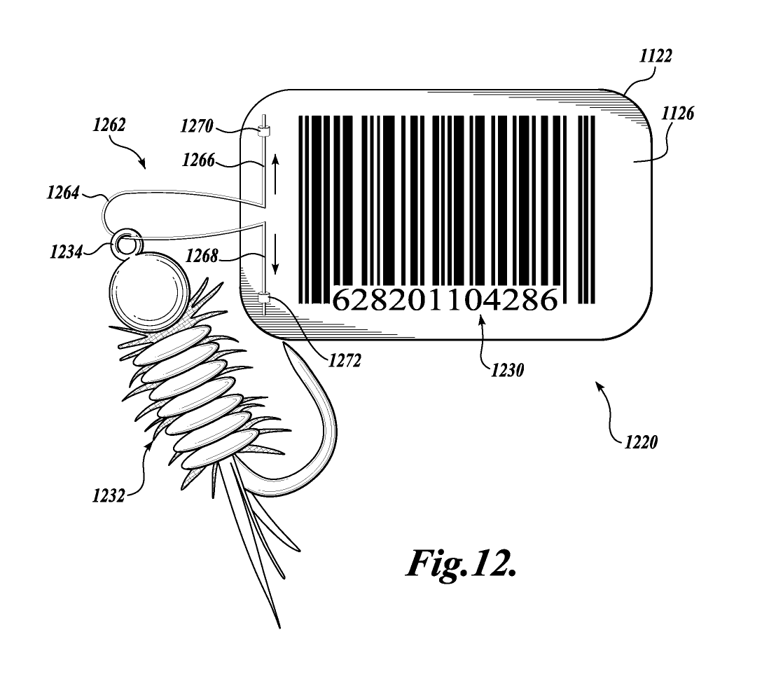

Referring to FIG. 12, a twelfth embodiment of the identification device 1220 includes a tag 1222 substantially identical to the tag 122 of the first embodiment except that the tag 1222 includes first and second openings, or slits 1270 and 1272 formed near the edge of the tag 1222. The identification device 1220 further includes a wire form 1262 couplable to the tag 1222. The wire form 1262 includes a curved, or U-shaped portion 1264 and first and second insert portions 1266 and 1268 extending transversely therefrom. The wire form 1262 is made from a flexible, bendable material.

The slits 1270 and 1272 are adapted to receive the first and second insert portions 1266 and 1268 of the wire form 1262. To insert the first and second insert portions 1266 and 1268, the U-shaped portion 1264 is squeezed to decrease the width of the wire form 1262, and the insert portions 1266 and 1268 are then inserted into the slits 1270 and 1272. After the insert portions 1266 and 1268 are received within the slits 1270 and 1272, they slide or move within the slits until the bent portion 1264 substantially returns to its original shape. As such, the wire form 1262 is retained within the tag 1222.

Before coupling the wire form 1262 to the tag 1222, the wire form 1262 is passed through the eye 1234 of the product 1232. Thus, when the first and second insert portions 1266 and 1268 are received within the slits 1270 and 1272, the product is secured to the tag 1222.

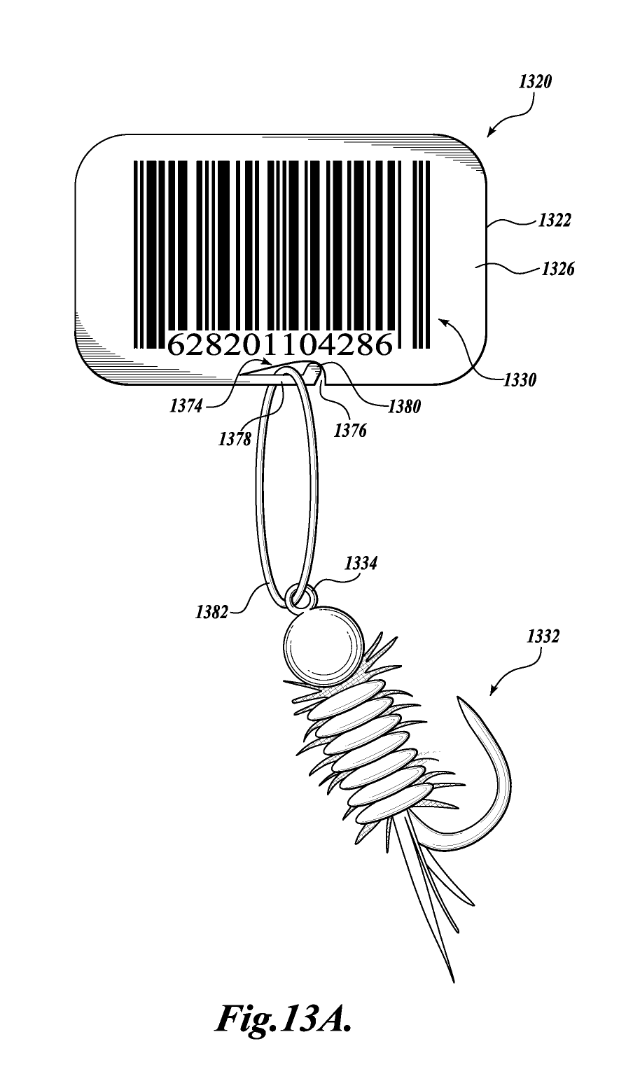

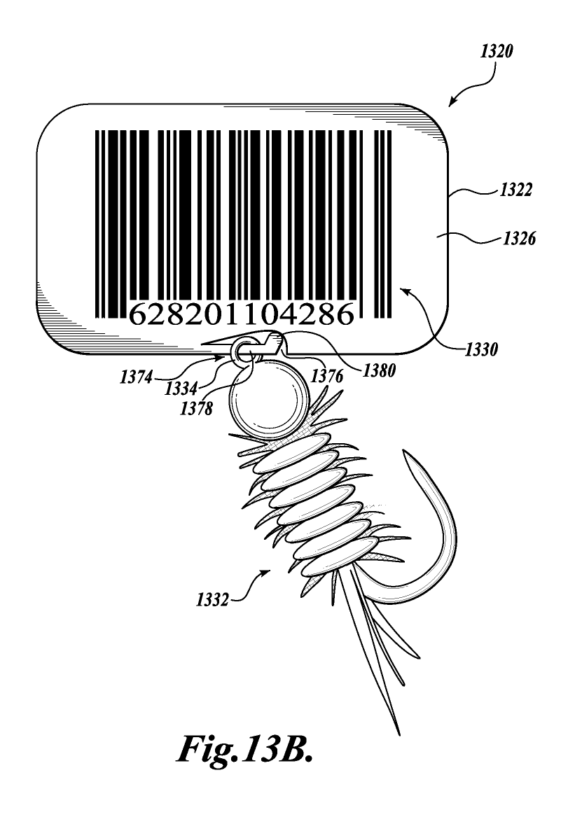

Referring to FIGS. 13A and 13B, a thirteenth embodiment of the identification device 1320 includes a tag 1322 substantially identical to the tag 122 of the first embodiment except that the tag 1320 includes a clip 1374 formed along an edge of the tag 1322. The clip 1374 is formed by cutting inwardly along the edge of the tag 1322 to define an opening 1376. A portion of the tag 1322 near the opening 1376, or an arm 1378, remains attached to the tag 1322 to extend into and partially block the opening 1376. The end of the arm 1378 includes a knob 1380 that extends inwardly from the arm 1378 to abut the tag 1322.

Referring specifically to FIG. 13A, to couple a product 1332 to the tag 1322, a loop member 1382 may be first passed through the eye 1334 of the product 1332. A portion of the loop member 1382 may thereafter be urged over the knob 1380 of the clip 1374 to be received in the opening 1376 between the arm 1378 and the tag 1322. The tag 1322 is made of a semi-deformable material such that the arm 1378 can bend outwardly to receive the loop member 1382 therewithin. The knob 1380 prevents the loop member 1382 from being removed from the clip 1374 without a substantial amount of force.

Referring to FIG. 13B, the product 1332 may instead be directly coupled to the tag 1322 by urging the eye 1334 over the knob 1380 of the clip 1374 to disposed the eye 1334 between the arm 1378 and the tag 1322.

While illustrative embodiments have been illustrated and described, it will be appreciated that various changes can be made therein without departing from the spirit and scope of the invention.

The embodiments of the invention in which an exclusive property or privilege is claimed are defined as follows:

1. An identification device attachable to a product, comprising:
(a) a tag having at least one face for bearing identification information; and
(b) a tail having first and second ends that is couplable to said tag at its first end such that it extends outwardly therefrom, the second end of the tail adapted to pass through a portion of the product and thereafter be enlarged.

2. The identification device of claim 1, wherein the tail passes transversely through the tag.

3. The identification device of claim 1, wherein the tail and the tag are in substantially the same plane when the tail is coupled to the tag.

4. The identification device of claim 1, wherein the first end of the tail is coupled to the tag by passing the first end of the tail through a portion of the tag and thereafter enlarging the first end of the tail.

5. The identification device of claim 4, wherein the first end of the tail is enlarged by either heating, crimping, flaring, or spreading.

6. The identification device of claim 4, wherein the first end of the tail is enlarged by twisting.

7. The identification device of claim 4, wherein the first end of the tail includes a deformable end tip that expands after passing through the tag.

8. The identification device of claim 4, wherein the first end of the tail is inserted within an end cap.

9. The identification device of claim 1, wherein the second end of the tail is enlarged by either heating, crimping, flaring, or spreading.

10. The identification device of claim 1, wherein the second end of the tail is enlarged by twisting.

11. The identification device of claim 1, wherein the second end of the tail is inserted into an end cap.

12. The identification device of claim 1, wherein the second end of the tail includes a deformable end tip that expands after passing through the portion of the product.

13. An identification device attachable to a product, comprising:
(a) a tag having at least one face for bearing identification information; and
(b) a tail having first and second ends that is coupled to said tag at its first end such that it extends outwardly therefrom, the second end of the tail adapted to pass through a portion of the product and thereafter be received within an end cap.

14. The identification device of claim 13, wherein the tail and the tag are in substantially the same plane when the tail is coupled to the tag.

15. An identification device attachable to a product, comprising:
(a) a tag having at least one face for bearing identification information; and
(b) a tail having first and second ends and coupled to said tag at its first end such that it extends outwardly therefrom, the second end of the tail adapted to pass through a portion of the product and thereafter be enlarged by twisting.

16. The identification device of claim 15, wherein the tail and the tag are in substantially the same plane when the tail is coupled to the tag.

17. An identification device attachable to a product, comprising:
(a) a tag having at least one face for bearing identification information; and
(b) a flexible element having first and second ends, the flexible element coupled to the tag and passing through at least a portion of the product to couple the product to the tag, wherein the first and second ends of the flexible element are thereafter joined together.

18. The identification device of claim 17, wherein the flexible element is a wire clip.

19. The identification device of claim 17, wherein the flexible element is a flexible loop and the first and second ends are coupled together with an end cap.

20. An identification device attachable to a product, comprising:
(a) a tag having at least one face for bearing identification information; and
(b) a line passing through a portion of the product, the line having a curved portion and first and second insert portions extending transversely therefrom, the first and second insert portions receivable within first and second openings in the tag.

21. An identification device attachable to a product, comprising:
(a) a tag having at least one face for bearing identification information; and
(b) portions of the tag configured to define a clip shaped to receive at least a portion of the product.

22. The identification device of claim 21, further comprising a loop member that engages with a portion of the product and couples the product to the clip.
